(19) United States
(12) Patent Application Publication
(10) Pub. No.: US 2012/0185274 A1
(43) Pub. Date: Jul. 19, 2012

(54) System and Method for Predicting Inner Age

(76) Inventor: Guzihou Hu, Cary, NC (US)

(21) Appl. No.: 13/350,427

(22) Filed: Jan. 13, 2012

Related U.S. Application Data
(60) Provisional application No. 61/432,768, filed on Jan. 14, 2011.

(51) Int. Cl. G06Q 50/24

(52) U.S. Cl. 705/3

(57) ABSTRACT

A method and system use a combined contribution of multiple disease risk factors to predict the risk of onset of particular diseases in an individual. The prediction models use information from separate studies. Multiple disease predictions for a predetermined number of diseases are made. The predictions are used to calculate the individual's mortality risk and life expectancy. The life expectancy is compared to that of age and gender matched peers to determine the inner age of the individual.

### CROSS REFERENCE TO RELATED APPLICATIONS

This application is related to U.S. Provisional Application Ser. No. 61/432,768, filed Jan. 14, 2011 by the same inventors herein. Applicant hereby claims priority to the Jan. 14, 2011 filing date of Application Ser. No. 61/432,768, and specifically incorporates the disclosure thereof in its entirety by reference herein. This application is also related to U.S. Pat. No. 6,110,109 and describes an invention which can employ the methodology described therein. The disclosure of U.S. Pat. No. 6,110,109 is also specifically incorporated herein in its entirety.

### FIELD OF THE INVENTION

The present invention relates to determining an individual's inner age. More particularly, the present invention relates to using the combined contribution of multiple disease risk factors to predict the risk of onset of a particular disease in an individual wherein the prediction models are constructed using information that is obtained from separate studies. Multiple disease predictions for a predetermined number of diseases are made. These predictions are used to calculate an individual's mortality risk and life expectancy. The life expectancy is then compared to the life expectancy of an age- and gender-matched peer in the general population to determine the inner age of the individual being assessed.

### BACKGROUND OF THE INVENTION

In public health, life expectancy has been used to indicate the general health status of a population. Life expectancy is typically calculated based on observed age-specific annual mortality in the population. It is very informative to use life expectancy to evaluate certain health risk factors in terms of how much the health risk factors could impact health. For example, studies have shown that smoking can reduce average life expectancy by 10-15 years.

In the field of health education, health wellness, and health promotion, it is desirable to calculate individual life expectancy by taking into account the multiple health risk factors the individual has. Such a calculation could provide a clear picture to the individual of how much the various health risk factors impact his/her overall health. It would be even more informative if it was possible to convert the individualized life expectancy into a physiological age, or “inner age.” The present invention provides a way to accomplish this.

To compute individual life expectancy and inner age requires prediction of the individual's future mortality beginning at the individual's current age and continuing to the end of life. This is typically achieved through statistical models which could be derived from longitudinal studies. However, comprehensive mortality prediction models are rarely available in the literature because of the following two reasons. First, mortality studies require large sample sizes and extensive follow-up intervals, which means they are very expensive to conduct, and therefore the number of such studies available in the literature is very limited. Second, considering the limited number of mortality follow-up studies published in the literature, to date, no study has able to generate comprehensive individual mortality prediction models because it is very difficult to include information on an all-inclusive and ever-increasing list of heath risk factors. The best knowledge gained from these studies is typically how a single risk factor impacts mortality, not how multiple risk factors jointly and comprehensively impact mortality; the latter is needed for the invention.

To overcome the above problem, the present invention uses at least one morbidity prediction model and then converts the morbidity prediction into mortality prediction. The morbidity prediction model defines how multiple disease risk factors impact the probability of having onset of a given disease within a specified period of time. Conventionally, the morbidity prediction model is derived from a comprehensive morbidity follow-up study. A few of these types of studies are available in the literature, such as the Framingham heart disease prediction model, which is derived from the Framingham heart disease follow-up study. However, despite a shorter follow-up duration since disease follow-up time is shorter than death follow-up time, many of the limited resources previously mentioned for mortality research are also applicable to morbidity prediction model studies; therefore, the number of morbidity prediction models is very limited and those available are typically less comprehensive and only account for a small number of disease risk factors. While it is difficult to include a comprehensive list of risk factors in one follow-up study, there are a sufficient number of studies published in the literature reporting a shorter list of risk factors, and their association to the risk of disease onset. Because the list of disease risk factors is very long and is constantly increasing, a single study including all risk factors is nearly impossible; rather, disease risk factors and their associations with mortality are frequently reported in disparate studies in the literature. Therefore, it is desirable to be able to combine the information from different studies and construct a comprehensive morbidity prediction model.

The invention of U.S. Pat. No. 6,110,109 provides a way to construct a comprehensive morbidity prediction model using information derived from different studies. The present invention describes implementation of comprehensive morbidity prediction models, such as that of U.S. Pat. No. 6,110,109 in assessing a person's “inner age.”

### SUMMARY OF THE INVENTION

The present invention is directed to a method and apparatus for assessing a person's inner age based on the person's plurality of disease prediction factors. It includes the following steps.

First, obtain a plurality of disease prediction factors from the assessed individual. Then, construct a multivariate prediction equation for a disease that contributes significantly to the person's future mortality risk, and apply this multivariate disease prediction equation to a plurality of disease prediction factors for the person to determine the disease status of that person.

The first step described in the prior paragraph is the method described in U.S. Pat. No. 6,110,109.

In accordance with the present invention, the disease prediction calculation is repeated to include multiple diseases that are believed to contribute significantly to mortality.

The multiple disease predictions are converted to a mortality prediction based on the cause-of-death contribution from each selected disease. The mortality prediction is further adjusted if and when desired to account for the effect of certain health risk factors on mortality, an effect that extends beyond the impact of these risk factors on morbidity of the selected diseases.

The mortality predictions are repeated at single-year age intervals from the individual's current age to age 100. Then the assessed individual's life expectancy is calculated by applying prior art standard life table methodology.

Finally, the life expectancy data from the general population for a given age, gender, and race are obtained, and the life expectancy of the assessed individual is compared with the general population to obtain the individual's “inner age.”

### BRIEF DESCRIPTION OF THE DRAWINGS

FIG. 1 illustrates in schematic form the general steps of the method of embodiments of the invention.

FIG. 2 illustrates in block diagram an apparatus for implementing the method of embodiments of the invention.

### DETAILED DESCRIPTION OF EXEMPLARY EMBODIMENTS OF THE INVENTION

The present invention of determining an individual's inner age can be divided into two main steps. The first step is to determine the individual's morbidity risk of developing a specific disease. The second step is to convert the morbidity risk into mortality risk and then to compute life expectancy and inner age. These two processes are explained in detail as follows:

### Determining an Individual's Morbidity Risk

To compute an individual's morbidity risk requires obtaining data on a plurality of disease prediction factors for the person and applying a multivariate disease prediction equation to that person's data.

Because comprehensive morbidity prediction models are rarely available in medical literature, the method of U.S. Pat. No. 6,110,109 may be used to construct such an equation, which allows for the integration of information from different studies.

The multivariate disease prediction equation may be of the form:

logit P=a+ΣbᵢXᵢ,

This is a standard prior art multivariate logistic regression equation where the logit P is the logit transformation of the probability (P) of the outcome, for example, representing a specific future disease risk for a specific person (e.g., the probability of developing coronary heart disease); the constant “a” represents the logit P when all disease prediction factors equal zero; Xᵢ represents a quantitative value assigned to each specific disease prediction factor for the individual (e.g., is this person a current smoker, does he/she have a family history of disease, what is the current blood pressure reading, what are the values from the lipid panel, etc.); bᵢ is the partial regression coefficient and represents the contribution of each factor to disease outcome, which is summarized from i=1 to i=j, where j is the total number of disease prediction factors specific to the individual assessed.

As discussed above, a multivariate equation of logit P=a+Σbᵢ Xᵢ, which includes a comprehensive number of disease prediction factors, has not been published in the literature. Instead, numerous reports have been published of equations in the form of logit P=a+bᵤᵢXᵢ, which is a univariate prediction equation, describing how each individual disease prediction factor Xᵢ (such as smoking) relates to the risk of disease without taking into account other disease prediction factors, and where bᵤᵢ is a univariate regression coefficient for Xᵢ.

The present invention provides a way to construct a multivariate prediction equation in the form of logit P=a+Σbᵢ Xᵢ using multiple logit P=a+bᵤᵢXᵢ as input.

To use this technique, a large cross-sectional population database which contains all the Xᵢ is needed. The National Health and Nutritional Health Examination Survey (NHANES) database, a publicly released database from the Centers for Disease Control and Prevention, is an example of such a database.

As an example of this method described below, we describe a multivariate prediction model to predict the risk of coronary heart disease (CHD) using three disease prediction factors: age, body mass index (BMI) and blood cholesterol.

In this example, we assumed we can obtain the following three univariate prediction equations from the literature. This information is typically available in meta-analysis as follows:

logit P_{age}=a+bᵤ_{_{—}}_{age}(age)

logit P_{bmi}=a+bᵤ_{_{—}}_{bmi}(BMI)

logit P_{cholesterol}=a+bᵤ_{_{—}}_{cholesterol}(Cholesterol)

Also available are the cross-sectional data which include age, BMI and cholesterol level for every subject in a large population. The data are analogous to the NHANES III data. The data for this example are displayed in the following Table.

TABLE

| | | | CHOLESTEROL |
|---|---|---|---|
| SUBJECT | AGE | BMI | LEVEL |
| 1 | 25 | 23 | 142 |
| 2 | 30 | 35 | 167 |
| — | — | — | — |
| N | — | — | — |

As seen in the Table, subject 1 is 25 years old, has a BMI of 23, and a cholesterol level of 142. Subject 2 is 30 years old, has a BMI of 35, and has a cholesterol level of 167. The data are collected and tabulated for all N subjects in a population.

The first step in this method is to calculate logit P_{age}, using the first univariate prediction model. Logit P_{age}=a+bᵤ_{_{—}}_{age}(age) for every subject in the population in Table. This will give N logit P_{age}.

In the second step, a prior art weighted OLS regression is run on the population data with P_{age}*(1−P_{age}) as the weight, the logit P_{age} as a dependent variable, and BMI as an independent variable. This step results in an equation of the following form:

logit P_{age}=a+b_{bmi}(BMI)

where b_{bmi} reflects the association between BMI and CHD, which had already been captured in the age-CHD equation due to the correction between BMI and age. In other words, b_{bmi} indicates how much of the association between BMI and the probability of developing CHD is already captured by the age-CHD model.

At this point, the univariate association between BMI and the probability of developing CHD is known (represented by bᵤ_{_{—}}_{bmi}), and the association between BMI and CHD that is captured by the age-CHD model is known (represented by b_{bmi}). Thus, there is a portion of the univariate association bᵤ_{_{—}}_{bmi} that is not captured in the age-CHD model; this amount is called bₑₓₜᵣₐ_{_{—}}_{bmi}. This bₑₓₜᵣₐ_{_{—}}_{bmi} is separated from bᵤ_{_{—}}_{bmi} and subsequently added to the age-CHD equation to make the first univariate age-CHD prediction equation into a multivariate equation which includes age and BMI. bₑₓₜᵣₐ_{_{—}}_{bmi} is calculated by subtracting b_{bmi} from bᵤ_{_{—}}_{bmi} and results in an multivariate equation in the form

logit P_{age,bmi}=a+bᵤ_{_{—}}_{age}(age)+bₑₓₜᵣₐ_{_{—}}_{bmi}(BMI)

The new intercept “a” is obtained by applying the above equation to the population data and using the average CHD incidence, the average age and the average BMI in the data to compute an adjusted average logit P_{age,bmi}.

As explained above, the age-CHD equation can be viewed as a baseline prediction; the method explained above allows integration of additional disease risk factors (BMI in this case) into the baseline prediction equation to make the prediction more comprehensive. Using the same logic, additional disease risk factors (such as cholesterol in the next equation) can be added resulting in a multivariate equation in the form of:

logit P_{age,bmi,cholesterol}=a+bᵤ_{_{—}}_{age}(age)+bₑₓₜᵣₐ_{_{—}}_{bmi}(BMI)+bₑₓₜᵣₐ_{_{—}}_{cholesterol}(Cholesterol).

This example illustrates the method with three disease prediction factors. A true CHD prediction may include, for example, 10 to 20 risk factors; therefore, the process described above will be used repeatedly until all risk factors are included, resulting in the most comprehensive multivariate CHD risk prediction model.

According to standard logistic regression, the logit P and P (the probability) can be interchanged based on the following formula:

logit P=log(P/(1−P)) or P=1/(1+exp(−logit P)).

The method described above is the method of U.S. Pat. No. 6,110,109, which represents the main component of the first step in the two-step inner age determination process of the present invention.

Although the present invention is based on applying a multivariate disease prediction equation obtained in the above-described manner, one would not actually need to develop the multivariate disease prediction equation in order to fall fully within the scope and spirit of practicing the present invention. For example, one could practice the present invention by selecting a multivariate disease prediction equation, which has been developed by others in accord with the methodology of the present invention, and then applying the equation to a plurality of a person's disease prediction factors to determine that person's disease status. The results when calculated for a predetermined set of diseases could then be applied to the methodology of some embodiments of the invention to arrive at a person's inner age.

It is up to the evaluator to determine which disease to be included with morbidity prediction models. The general principle is to select those diseases that will significantly impact the assessed individual's future mortality. For example, CHD, diabetes, stroke, and certain types of cancers are contributing causes to the majority of deaths among general individuals living in modern society.

The second step of the inner age determination process is to convert the morbidity prediction into mortality prediction and compute life expectancy and inner age. This is described in detail as follows:

Converting Morbidity Prediction into Inner Age

This process can be described as a 12-step process. In accordance with some embodiments of the invention in step 1, data for a plurality of disease prediction factors are obtained for a particular person. Thereafter, in step 2, data for a plurality of disease prediction factors on average for the general population of the same age and gender are obtained. The NHANES data could be a typical source of such average population data. In step 3, the individual's data and the general population data are applied to disease prediction equations, as previously described, to generate the individual's specific disease risk and the population averages for the same disease. In step 4, the morbidity relative risk for an individual is determined (i.e., individual disease risk divided by population average risk) for the given disease where:

RRᵢ=Pᵢ/Pᵢₘ

RRᵢ: Relative risk for a given disease i

Pᵢ: Individual risk of given disease i

Pᵢₘ: Same age and gender population average risk of given disease i

i=1 to j, where j is the number of disease selected.

In step 5, the foregoing steps are repeated to include multiple diseases beginning with i=1 to j, where j is the number of diseases selected.

In step 6, data are obtained on disease-specific mortality for each of the considered diseases in the general population, M₁ₘ, M₂ₘ . . . Mⱼₘ, at a given age and gender. For example, if the first disease is CHD and the assessed individual is a 50-year-old male, then M₁ₘ is the average annual mortality due to CHD for a population (such as average Americans) at age 50 in males. These data are generally available from CDC tables or other sources. At the same time, data on the overall mortality in the general population at the given age and gender M can also be obtained from CDC tables. For example, M is the combined all-cause, annual mortality in 50-year-old American males.

In step 7, the individual's mortality relative risk (RR) is determined based on the inputs derived previously by the following equation

RR=exp((M₁ₘ/M)log(RR₁)+(M₂ₘ/M)log(RR₂) . . . +(Mⱼₘ/M)log(RRᵢ))
where log represents a natural log transformation and i=1 to j, where j is the number of diseases selected.

In step 8, individual predicted mortality is generated by multiplying the mortality relative risk (RR) by total mortality (M). During this step, the individual mortality may require an adjustment depending on the number of diseases selected in the above process. The adjustment is an effort to account for the impact of certain risk factors on mortality that could be beyond their impact on the selected diseases. In theory, if the diseases selected for the morbidity prediction equations include all possible diseases the individual could die from, then no adjustment would be needed. Practically, however, the selected diseases within the morbidity prediction may only include the diseases that contribute to the majority of causes of death (e.g., CHD, stroke, diabetes, and certain types of cancer). In this situation, certain health risk factors, such as smoking, could impact mortality by affecting the risk of diseases other than those selected. So the impact of smoking on overall mortality would be underestimated without the adjustment.

The adjustment process is explained as follows. First, a representative population dataset, such as NHANES, is obtained, and the method described above is applied to each individual in the data to generate an unadjusted, individual mortality estimate. Second, the relation between the unadjusted predicted mortality and a selected disease risk factor (such as smoking) is evaluated using prior art methodology, such as regression analysis or analysis of variance. The conclusion of such an evaluation may show, for example, the unadjusted predicted mortality is 10-fold higher for people who smoke than those who do not smoke. This information is then compared with published reports in the literature describing the impact of the selected risk factor (smoking) on mortality. If a significant discrepancy exists, for example, the literature reports that smokers have a 15-fold higher mortality than nonsmokers, an adjustment is needed. As previously explained, such a discrepancy results from the fact that smoking impacts mortality through diseases other than those selected for inclusion in the morbidity prediction; therefore, the mortality prediction should be adjusted and the difference between the above two discrepant numbers integrated. In this particular example, additional weight will be added to smoking, and the adjustment equation may be as follows:

M_{adjusted}=1/exp(−log(M_{unadjusted}(1−M_{unadjusted}))−log(15/10)*(smoking))),

where smoking=1 if smoker, 0 if nonsmoker.

All disease risk factors may be evaluated and adjustments may be made.

In step 9, the individual's final mortality estimate is determined after all adjustments.

In step 10, using all aforementioned calculations, the individual's age is increased by 1 and the previous steps are repeated until the individual's simulated age=100 years and where mortality is equated to 1 as age 100 (i.e., M_{age}, M_{age+1} . . . M₁₀₀). In step 11, the individual's life expectancy is determined based on the array of mortality from the previous step. The life table method is the standard prior art method to compute life expectancy using arrays of mortality. In step 12, data on the life expectancy for the general population are obtained for a given gender and race, and the life expectancy of the assessed individual is compared with the general population to obtain the individual's inner age. For example, a 50-year-old Caucasian male has a life expectancy of 28 years, which is equivalent to the life expectancy of an average Caucasian American at age 55; this assessed individual has an estimated inner age of 55, even though his chronological age is 50.

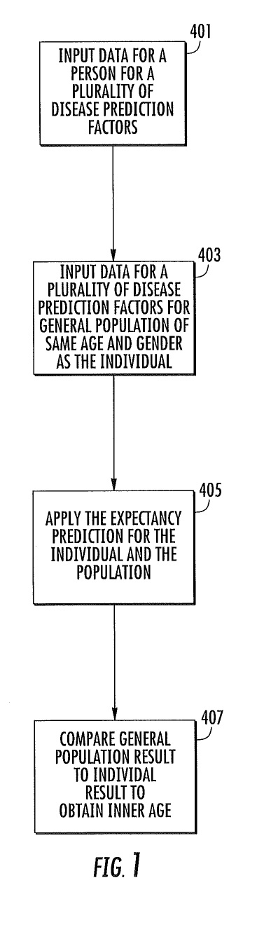

FIG. 1 illustrates in schematic form the general steps of the method of some embodiments. More specifically, in step 401, the individual's risk/prediction factor data, as associated with a plurality of diseases, are used in the individual's mortality prediction equation. In step 403, the same risk/prediction factor data are used for a plurality (the same plurality) of diseases within the general population, which is matched by age and gender to the individual in step 401.

In step 405, the mortality or life expectancy prediction is applied for the individual and the aforementioned matched general population. These results are compared, based on life expectancy, to arrive at an individual's inner age, as shown in step 407.

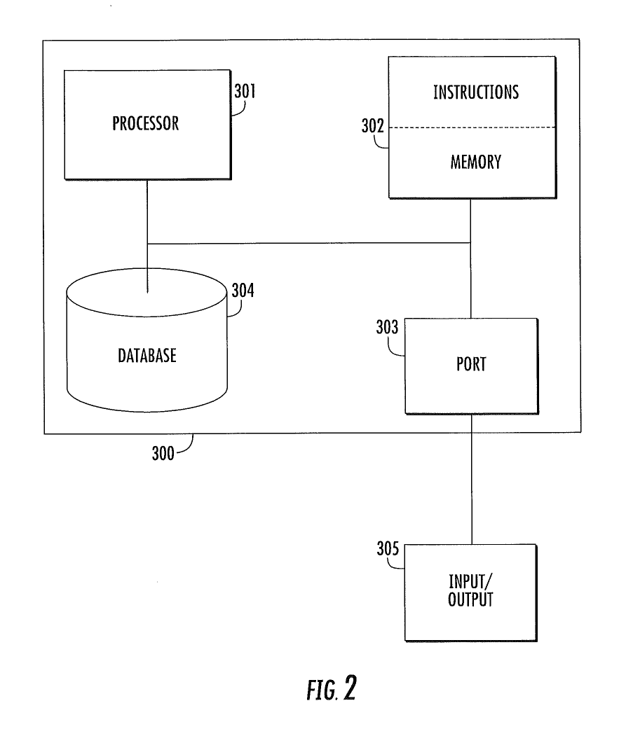

An apparatus for assessing disease status and ultimately determining inner age according to the method of the present invention is illustrated in FIG. 2. The apparatus 300 may be comprised of a processor 301 and a memory 302 coupled to the processor. The memory 302 and the processor 301 may be further coupled to a database 304 for storing data on a plurality of disease prediction factors for a person and to a port 303 for inputting or outputting data from or to an input or output transfer means 305. The memory 302 may store instructions that are adapted to be executed by the processor using the data on the plurality of disease prediction factors to determine the disease status of the person. The disease status can then be used to calculate inner age as previously described. The instructions that are stored in the memory may include, in particular, instructions for applying the multivariate disease prediction equation that is obtained according to the methodology disclosed herein, and the equations which use the disease prediction to determine inner age. The results may then be output through port 303.

Any suitable output format may be used, and an inner age report may be generated including the results described herein. For example, the generated inner age may be provided as a result to a user in the form of a report that may provide a health risk assessment and inner age. Accordingly, the health risk assessment may provide the inner age of the individual, e.g., that a 25 year old may have an inner age of 35. The report may be displayed on a display screen, printed, and/or provided in an electronic format. Electronic reports may include exportable formats for electronic transmission via various ways for others to view an individual's health risk assessment, which may include the “inner age” component. Alternatively, no health risk assessment may be provided, and the “inner age” may be provided alone.

The present invention may be further directed to the medium for storing the instructions that are used for assessing a person's disease status and that are adapted to be executed by a processor.

The present invention is described herein with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, embodiments of the present invention may take the form of a computer program product on a computer-usable or computer-readable non-transient storage medium having computer-usable or computer-readable program code embodied in the medium for use by or in connection with an instruction execution system.

For the purposes of this application, a memory may include any medium capable of storing instructions adapted to be executed by a processor. Some examples of such media include, but are not limited to, floppy disks, CDROM, magnetic tape, hard drives, and any other device that can store digital information. In one embodiment, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A computer implemented method for assessing an individual's inner age based on the individual's disease prediction factors, comprising:
(a) obtaining a plurality of disease prediction factors from an assessed individual, and constructing a multivariate prediction equation for diseases that contribute significantly to the individual's future mortality risk;
(b) applying the multivariate prediction equation corresponding to diseases that contribute significantly to the individual's future mortality risk to obtain a plurality of disease predictions, each prediction corresponding to a specific disease;
(c) converting the plurality of disease predictions to a mortality prediction based on a cause-of-death contribution from each selected disease;
(d) adjusting the mortality prediction to account for health risk factors on mortality extending beyond the impact of said health risk factors in mortality of the diseases;
(e) repeating the mortality prediction calculations at single-year age intervals from any individual's current age to age 100;
(f) calculating the individual's life expectancy from standard life tables; and
(g) obtaining life expectancy data for the general population and comparing the life expectancy of the individual to the general population data to obtain the individual's inner age.

2. The method of claim 1, wherein the multivariate prediction equation is a logistic regression of the form: logitP=a+ΣbᵢXᵢ; where logit P is a logit transformation of a probability (P) of an outcome representing a specific future disease risk for a specific person; the constant “a” represents the logit P when all disease prediction factors equal zero; Xᵢ represents a quantitative value assigned to each specific disease prediction factor for the individual; and bᵢ is the partial regression coefficient and represents a contribution of each factor to disease outcome which is summarized from i=1 to i=j, where j is a total number of disease prediction factors specific to the individual assessed.

3. The method of claim 2, further comprising constructing the equation P=a+ΣbᵢXᵢ using multiple logit P=a+bᵤᵢXᵢ equations as input, wherein bᵤᵢ is a univariate regression coefficient for Xᵢ.

4. The method of claim 1, further comprising using a cross-sectional population database which contains all the Xᵢ needed.

5. The method of claim 4, wherein the database is the NHANES database.

6. The method of claim 1, wherein the multivariate prediction model is configured to predict the risk of heart disease using age, body mass index (“BMI”) and blood cholesterol values as the disease prediction factors.

7. The method of claim 6, wherein three univariate prediction equations are used, which are in the form of logit P_{age}=a+b_{u-age}(age), logit P_{bmi}=a+b_{u-bmi}(BMI), and logit P_{cholesterol}a+b_{u-cholesterol}(Cholesterol)

8. A computerized system for assessing an individual's inner age, comprising:
(A) a database, processor, memory, instructions, a port for receiving input and transmitting output, and an input/output module; and
(B) said system further programmed to implement a computer implemented method for assessing an individual's inner age based on the individual's disease prediction factors, comprising:
(a) obtaining a plurality of disease prediction factors from an assessed individual, and constructing a multivariate prediction equation for diseases that contribute significantly to the individual's future mortality risk;
(b) applying the multivariate prediction equation corresponding to diseases that contribute significantly to the individual's future mortality to risk to obtain a plurality of disease predictions, each prediction corresponding to a specific disease;
(c) converting the plurality of disease predictions to a mortality prediction based on a cause-of-death contribution from each selected disease;
(d) adjusting the mortality prediction to account for health risk factors on mortality extending beyond the impact of said health risk factors in mortality of the diseases;
(e) repeating the mortality prediction calculations at single-year age intervals from any individual's current age to age 100;
(f) calculating the individual's life expectancy from standard life tables; and
(g) obtaining life expectancy data for the general population and comparing the life expectancy of the individual to the general population data to obtain and then provide the individual's inner age.

9. The system of claim 8, wherein the multivariate prediction equation is a logistic regression of the form: logitP=a+ΣbᵢXᵢ; where logit P is a logit transformation of a probability (P) of an outcome representing a specific future disease risk for a specific individual; the constant “a” represents the logit P when all disease prediction factors equal zero; Xᵢ represents a quantitative value assigned to each specific disease prediction factor for the individual; and bᵢ is the partial regression coefficient and represents a contribution of each factor to disease outcome which is summarized from i=1 to i=j, where j is a total number of disease prediction factors specific to the individual assessed.

10. The system of claim 9, further comprising constructing the equation P=a+ΣbᵢXᵢ using multiple logit P=a+bᵤᵢXᵢ equations as input, wherein bᵤᵢ is a univariate regression coefficient for Xᵢ.

11. The system of claim 8, further comprising using a cross-sectional population database which contains all the Xᵢ needed.

12. The system of claim 11, wherein the database is the NHANES database.

13. The system of claim 8, wherein the multivariate prediction model is configured to predict the risk of heart disease using age, body mass index (“BMI”) and blood cholesterol values as the disease prediction factors.

14. The system of claim 13, where three univariate prediction equations are used, which are in the form of logit P_{age}=a+b_{u-age}(age), logit P_{bmi}=a+b_{u-bmi}(BMI), and logit P_{cholesterol}=a+b_{u-cholesterol}(Cholesterol)
